(19) United States
(12) Patent Application Publication
(10) Pub. No.: US 2007/0273961 A1
(43) Pub. Date: Nov. 29, 2007

(54) Light Pulse Amplification In Long Optical Fibers

(75) Inventor: Kari-Mikko Jääskeläinen, Houston, TX (US)

Correspondence Address: SHELL OIL COMPANY, P O BOX 2463, HOUSTON, TX, 772522463, US

(73) Assignee: SHELL OIL COMPANY, Houston, TX (US)

(21) Appl. No.: 11/631,758

(22) PCT Filed: Jul. 6, 2005
(86) PCT No.: PCT/EP05/53218

§ 371 Date: Jan. 5, 2007

(30) Foreign Application Priority Data
Jul. 6, 2004 (EP) 04103182.4

(51) Int. Cl. H01S 3/30

(52) U.S. Cl. 359/334

(57) ABSTRACT

A method is disclosed for amplifying a light pulse (S) in an optical fiber (1), wherein a Raman pump signal (RPS) having a lower wavelength than the light pulse (S) is transmitted at a selected interval of time after the light pulse (S) into an end (IA) of an optical fiber(1), with dispersion such that the Raman pump signal (RPS) travels faster through the fiber(1) than the light pulse(S) and reaches and enhances the light pulse (S) after the light pulse has travelled along a selected distance (d1) through the fiber, wherein the Raman pump signal (RPS) is ramped in a substantially linear manner such that the amplification increases with the distance along which the light pulse has travelled along the length of the fiber from A₁=S₁+RPSₘᵢₙ at a distance d1 to A₂=S+RPSₘₐₓ at a distance d₂>d₁ from said end (IA) of the fiber 1 and such that the Raman gain increase is substantially similar to the fiber losses of the amplified signal. The use of a ramped Raman pump signal (RSP) mitigates Stimulated Brillouin Scattering (SBS) in the fiber (1) and extends the operational range of a fiber optical sensing system.

### BACKGROUND OF THE INVENTION

The invention relates to a method and system for amplifying a light pulse in an optical fiber.

If light pulses are transmitted through long optical fibers the strength of the light pulses is gradually decreased due to reflection, scattering and/or absorption of the photons that are emitted through the optical fiber and reflected by a reflective coating surrounding the optical fiber.

International patent application WO 02/13423 discloses a method for amplification of the attenuated signal by means of multiple amplification signals, which are generally known as a Raman pump signals. The known amplification method is generally known as Raman pumping and employs a pump signal that has a lower wavelength than the attenuated light pulse and is transmitted simultaneously and continuously with the signal light pulses into the fiber, such that the pump signal(s) interacts with the attenuated light pulses over a length of fiber, which may be between one and several hundreds of kilometres, and stimulated Raman scattering amplify the attenuated signal.

International patent application WO 00/65698 discloses a wide bandwidth Raman amplifier wherein at least three pump sources provide pump power at different pump wavelengths that are spaced apart from another such that a prescribed Raman gain profile is generated in the optical fiber portion.

International patent application WO 02/084819 discloses an optical amplification system employing multiple laser groupings to provide a desired, e.g. flat, gain profile over a selected range of optical signal wavelengths.

The article “Extended-range optical time domain-reflectometry (ODTR) system at 1650 nm based on delayed Raman amplification” published by Kee et al. in the magazine Optics Letters, Vol. 23, No. 5, 1 Mar. 1998 discloses a delayed Raman amplification of a 1650 nm signal pulse by a 1530 nm pump pulse, such that amplification occurs when the two pulses overlap, and the position where amplification occurs is determined by the initial delay between the pulses and the fiber dispersion.

The currently available Optical Time Domain Reflectometry based sensing techniques are limited in output power of the emitted light pulse due to Stimulated Brillouin Scattering (SBS) in the optical fiber. If a pump or signal light exceeds a certain power level in the fiber, the density of the fiber changes, which triggers SBS whereby most of the light bounces back to the direction it came from. The SBS effect limits the maximum range of the known sensing systems.

It is an object of the present invention to provide a Raman amplification method in which these limitations are alleviated.

It is a further object of the present invention to extend the range of a pulsed sensing system by Raman amplification in an optical fiber by amplifying/compensating remotely for fiber losses when the signal level has decreased such that SBS is mitigated.

### SUMMARY OF THE INVENTION

In accordance with the invention there is provided a method for amplifying a light pulse in an optical fiber, wherein a Raman pump signal having a lower wavelength than the light pulse is transmitted at a selected interval of time after the light pulse into the optical fiber, with dispersion such that the Raman pump signal travels faster through the fiber than the light pulse and reaches and enhances the light pulse after the light pulse has travelled along a selected distance through the fiber, wherein the Raman pump signal is ramped in a substantially linear manner such that the amplification increases with the distance along which the light pulse has travelled along the length of the fiber and such that the Raman gain is substantially similar to the fiber losses of the amplified signal.

When used in this specification and accompanying claims the term dispersion indicates that the speed of light in a fiber is different for different wavelengths. The term dispersion is also known as material dispersion and is a result of the physical effect that the index of refraction of a fiber core is different for different wavelengths, so that different spectral components (wavelengths) will propagate at different speeds along the length of the fiber.

The wavelength of the Raman pump signal may be between 50 and 250 nm lower than the wavelength of the light pulse and the wavelength of the light pulse may be between 1400 and 1700 nm and the Raman pump signal (RPS) increases in a substantially linear manner from A₁=S₁+RPSₘᵢₙ at a distance d₁ to A₂=S+RPSₘₐₓ at a distance d₂>d₁ from the point where the light pulse is transmitted into the optical fiber.

The Raman pump signal may be transmitted at such an interval of time after the light pulse and may have such a lower wavelength than the light pulse that the Raman pump signal reaches the light pulse at a point in the optical fiber which is located at a distance between 1 and 10 Kilometers from the point where the light pulse and Raman pump signal have been transmitted into the optical fiber.

The Raman pump signal may be ramped such that full gain of the light pulse by the Raman pump signal is accomplished at a distance of between 1 and 100 Kilometers from the point where the Raman pump signal has reached the light pulse.

Optionally, the Raman pump signal contains multiple Raman pumping wavelengths and is used to amplify both the light pulse and the part of the Raman pump signal that amplify the light pulse as they propagate down the fiber. In such case the different wavelengths of the Raman pump signal travel at different speed and overlap at different times/locations. In such case it is preferred that the spacing between the different pump sources is from 30 nm to 200 nm.

The system according to the invention for amplifying a light pulse in an optical fiber comprises a Raman pump signal transmitter for transmitting a Raman pump signal having a lower wavelength than the light pulse at a selected interval of time after the light pulse into the optical fiber, such that the Raman pump signal travels faster through the fiber than the light pulse and reaches and enhances the light pulse after the light pulse has travelled along a selected distance through the fiber, wherein the Raman pump signal is ramped such that the cumulative amplification increases with the distance along which the light pulse has travelled along the length of the fiber.

Optionally, the system is configured for use to extend the reach of pulsed systems where the travel time reflects position along a fiber.

The pulsed system may be a pulsed sensing system, such as an Optical Time Domain Reflectometry (ODTR) system based on Rayleigh backscattering, a Strain and/or Temperature sensing system based on Brillouin backscattering, a temperature sensing system based on Raman backscattering, an interferometric Fabry-Perot type sensing system, and/or a direct wavelength detection system based on Fiber Bragg Gratings (FBGs).

These and other features, embodiments and advantages of the method and system according to the invention will be apparent from the accompanying claims, abstract and the following detailed description of a preferred embodiment of the method and system according to the invention in which reference is made to the accompanying drawing.

### BRIEF DESCRIPTION OF THE DRAWING

FIG. 1 schematically illustrates an optical fiber through which a light pulse and a ramped Raman pump signal are transmitted such that the light pulse is amplified in a gradually increasing manner as it travels along the length of the fiber.

### DETAILED DESCRIPTION OF A PREFERRED EMBODIMENT

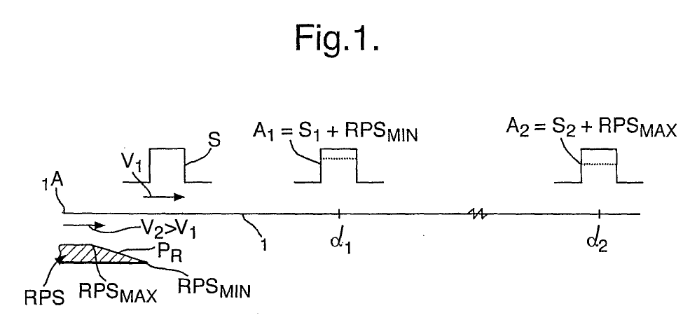

FIG. 1 schematically illustrates an optical fiber 1 through which a pulsed light signal S travels at a velocity v₁. At a selected interval of time after the pulsed light signal S has been transmitted into one end 1A of the fiber 1 a ramped Raman pump signal RPS is transmitted into said end 1A of the fiber. The wavelength of the pulsed light signal S may typically be between 15 and 16 μm and the wavelength of the Raman pump signal RPS may typically be between 14 and 15 μm. As a result of its lower wavelength the Raman pump signal RPS travels faster, at a velocity v₂>v1 through the fiber 1 than the pulsed light signal S and therefore the Raman pump signal RPS reaches the pulsed light signal S at a distance d1 from the first end 1A of the fiber1.

In accordance with the invention the Raman pump signal RPS is ramped, such that along the length of the ramped part RPSR the strength of the Raman pump signal RPS increases from RPSₘᵢₙ to RPSₘₐₓ.

Thus, when the Raman pump signal RPS reaches the pulsed light signal S at a distance d₁ from the first end 1A of the fiber 1 the Raman pump signal RPS only has its minimum strength RPSₘᵢₙ and the relatively strong light signal S1 is only amplified minimally, which is illustrated as A₁=S₁+RPSₘᵢₙ.

The Raman pump signal will from this point on continuously amplify the signal S₁ in a substantially linear manner equal to the fiber losses distributed along the length of the fiber.

At a distance d₂ the pulsed light signal has been maintained in strength and the Raman pump signal RPS has been weakened due to fiber losses and pump to signal energy transfer. The Raman pump signal will have a strength such that the resulting signal gain is equal to the fiber loss.

The use of a ramped Raman pump signal RPS keeps the signal level below the Stimulated Brillouin Scattering (SBS) threshold in the region between d₁ and d₂ such that the dynamic range and reach is increased of a fiber optical sensing system, such as an ODTR-system, in which the fiber 1 is employed as a fiber optical sensor.

1. A method for amplifying a light pulse in an optical fiber, wherein a Raman pump signal having a lower wavelength than the light pulse is transmitted at a selected interval of time after the light pulse into the optical fiber, with dispersion such that the Raman pump signal travels faster through the fiber than the light pulse and reaches and enhances the light pulse after the light pulse has travelled along a selected distance through the fiber, wherein the Raman pump signal is ramped in a substantially linear manner such that the cumulative amplification increases with the distance along which the light pulse has travelled along the length of the fiber and such that the Raman gain is substantially similar to the fiber losses of the amplified signal.

2. The method of claim 1, wherein the wavelength of the Raman pump signal is between 50 and 250 nm lower than the wavelength of the light pulse and the Raman pump signal (RPS) increases in a substantially linear manner from A₁=S₁+RPSₘᵢₙ at a distance d₁ to A₂=S+RPSₘₐₓ at a distance d₂>d₁ from the point where the light pulse is transmitted into the optical fiber.

3. The method of claim 2, wherein the wavelength of the light pulse is between 1400 and 1700 nm.

4. The method of claim 1, wherein the Raman pump signal is transmitted at such an interval of time after the light pulse and has such a lower wavelength than the light pulse that the Raman pump signal reaches the light pulse at a point in the optical fiber which is located at a distance between 1 and 10 Kilometers from the point where the light pulse and Raman pump signal have been transmitted into the optical fiber.

5. The method of claim 1, wherein the Raman pump signal is ramped such that full gain of the light pulse by the Raman pump signal is accomplished at a distance of between 1 and 100 Kilometers from the point where the Raman pump signal has reached the light pulse.

6. The method of claim 1, wherein the Raman pump signal contains multiple Raman pumping wavelengths and is used to amplify both the light pulse and the part of the Raman pump signal that amplify the light pulse as they propagate down the fiber.

7. The method of claim 6, wherein the different wavelengths of the Raman pump signal travel at different speed and overlap at different times/locations.

8. The method of claim 7, wherein the spacing between the different pump sources is from 30 nm to 200 nm.

9. A system for amplifying a light pulse in an optical fiber, the system comprising a Raman pump signal transmitter for transmitting a Raman pump signal having a lower wavelength than the light pulse at a selected interval of time after the light pulse into the optical fiber, such that the Raman pump signal travels faster through the fiber than the light pulse and reaches and enhances the light pulse after the light pulse has travelled along a selected distance through the fiber, wherein the Raman pump signal is ramped such that the amplification increases with the distance along which the light pulse has travelled along the length of the fiber.

10. The system of claim 9, wherein the system is configured for use to extend the reach of pulsed systems where the travel time reflects position along a fiber.

11. The system of claim 9, wherein the pulsed system is a pulsed sensing system, such as an Optical Time Domain Reflectometry (ODTR) system based on Rayleigh backscattering, a Strain and/or Temperature sensing system based on Brillouin backscattering, a temperature sensing system based on Raman backscattering, an interferometric Fabry-Perot type sensing system, and/or a direct wavelength detection system based on Fiber Bragg Gratings (FBGs).
